(19) United States
(12) Patent Application Publication
(10) Pub. No.: US 2015/0267480 A1
(43) Pub. Date: Sep. 24, 2015

(54) RATCHET ASSEMBLY

(71) Applicant: Seaboard International, Inc., Houston, TX (US)

(72) Inventor: Robert K. Meek, Bakersfield, CA (US)

(21) Appl. No.: 14/604,239

(22) Filed: Jan. 23, 2015

Related U.S. Application Data
(60) Provisional application No. 61/968,133, filed on Mar. 20, 2014.

(51) Int. Cl. E21B 17/10; F16H 31/00

(52) U.S. Cl. CPC E21B 17/1071; F16H 31/001

(57) ABSTRACT

Embodiments disclosed herein provide a ratchet assembly having a ratchet nut, a shaft at least partially disposed within the ratchet nut and a first and second pawl disposed within the ratchet nut and supported by the shaft. The first and second pawls are movable along a common central axis. The assembly further includes a biasing mechanism, the biasing mechanism biasing the first and second pawls in an engaged position to maintain contact with the ratchet nut to prevent relative rotation between the shaft and the ratchet nut. The assembly also includes an alignment pin extending at least partially within the first and second pawls to maintain alignment and to facilitate movement of the pawls along the common central axis.

### CROSS-REFERENCE TO RELATED APPLICATIONS

This application claims priority to U.S. Provisional Patent Application No. 61/968,133 filed Mar. 20, 2014, which is incorporated herein by reference in its entirety.

### TECHNICAL FIELD

This disclosure relates to a ratchet assembly for use in reciprocating oil pumps, and in particular, to a ratchet assembly that includes opposing pawls.

### BACKGROUND OF THE DISCLOSURE

Reciprocating oil pumps include a sucker rod that reciprocates in a production tubing of an oil well to pull oil, water or other fluids from the well. As the sucker rod reciprocates in the production tubing, contact between the sucker rod and the production tubing surface can cause erosion and wear on the sucker rod surface. In order to more evenly distribute wear on the sucker rod surface, reciprocating oil pumps often include a rod rotator to incrementally rotate the sucker rod and/or a tubing rotator to incrementally rotate the tubing. Rod rotators and tubing rotators typically include ratchet systems to incrementally rotate the rod or tubing and may also include ratchet systems to prevent the rod or tubing from rotating in a direction opposite from the desired direction of rotation. Unfortunately, current ratchet systems include parts that are difficult to assemble and are prone to misassembly and failure. In some cases, workers do not identify misassembled parts of the ratchet system until after the ratchet system has malfunctioned and the reciprocating sucker rod or tubing has not rotated for a period of time, thus causing increased wear on portions of the sucker rod or tubing and possibly causing premature failure of the sucker rod. It would therefore be desirable to have a ratchet system that is easy to assemble without including failure-prone parts.

### SUMMARY

In a first aspect, there is provided a ratchet assembly having a ratchet nut, a shaft at least partially disposed within the ratchet nut and a first and second pawl disposed within the ratchet nut and supported by the shaft. The first and second pawls are movable along a common central axis. The assembly further includes a biasing mechanism, the biasing mechanism biasing the first and second pawls in an engaged position to maintain contact with the ratchet nut to prevent relative rotation between the shaft and the ratchet nut. The assembly also includes an alignment pin extending at least partially within the first and second pawls to maintain alignment and to facilitate movement of the pawls along the common central axis.

In some embodiments, the first and second pawls each include an engagement surface configured to engage the ratchet nut and a non-engagement surface opposite the engagement surface that includes an alignment bore to receive the alignment pin therein.

In other embodiments, the alignment pin includes a hollow interior.

In still other embodiments, the ratchet nut is secured in a stationary position to facilitate rotational movement of the shaft relative to the ratchet nut.

In another embodiment, the first and second pawls each include a rectangular body having an angled engagement surface to engage the ratchet nut.

In still another embodiment, the non-engagement surfaces each include a biasing mechanism bore disposed adjacent the alignment bore and the biasing mechanism is at least partially disposed within the biasing mechanism bores.

In yet another embodiment, the non-engagement surfaces each includes a second biasing mechanism bore disposed adjacent the alignment bore and a second biasing mechanism is at least partially disposed within the second biasing mechanism bores.

In some embodiments, the alignment bores of the first and second pawls are located between the first biasing mechanism bores and the second biasing mechanism bores.

In other embodiments, the first and second pawls are disposed within an opening in the ratchet nut so that the engagement surfaces contact opposite interior surfaces of the opening.

In a second aspect, there is described, a ratchet assembly that includes a ratchet nut, a first pawl, a second pawl and an alignment pin. The ratchet nut includes a central opening and an interior surface that includes a plurality of teeth. The first pawl includes an engagement surface and a non-engagement surface opposite the engagement surface that includes an alignment bore. The second pawl also includes an engagement surface and a non-engagement surface opposite the engagement surface that includes an alignment bore. The alignment pin is disposed at least partially within the first and second alignment bores to constrain movement of the pawls along a common axis to engage the engagement surfaces of the first and second pawls with opposed teeth of the ratchet nut.

In some embodiments, the ratchet includes a shaft having a slot and the first pawl and the second pawl are at least partially positioned within the slot.

In other embodiments, the ratchet nut is secured in a stationary position to facilitate rotational movement of the shaft relative to the ratchet nut.

In still other embodiments, the ratchet includes a biasing mechanism disposed between the first pawl and the second pawl to position the engagement surfaces of the first and second pawls against internal surface of the ratchet nut.

In a third aspect, there is described a method of manufacturing a ratchet assembly that includes providing a first pawl and forming an alignment bore and a biasing mechanism bore therein. The method also includes providing a second pawl and forming an alignment bore and a biasing mechanism bore therein. The method includes inserting an alignment pin between the first pawl and the second pawl so that the pin is at least partially positioned within the alignment bores. The method includes inserting a biasing mechanism between the first pawl the second pawl so that the biasing mechanism is at least partially positioned within the biasing mechanism bores of the first and second pawls.

In some embodiments, the method includes moving the first pawl toward the second pawl to compress the biasing mechanism.

In other embodiments, the method includes inserting the first pawl and the second pawl within an internal opening of a ratchet nut.

In still other embodiments, the method includes inserting the first pawl and the second pawl into a slot of a worm shaft.

In yet other embodiments, the method includes releasing the first and second pawls such that the biasing mechanism moves first pawl away from the second pawl so that the first pawl and the second pawl contact opposite sides of the internal opening of the ratchet nut.

In another embodiment, the method includes forming an opening in the alignment pin that extends along the longitudinal axis of the alignment pin.

In still another embodiment, the method includes forming a second biasing mechanism bore on the first and second pawls and placing an additional biasing mechanism within the second biasing mechanism bores.

In a fourth aspect, there is described a pawl for use with a ratchet assembly. The ratchet assembly includes a ratchet nut and first and second pawls disposed within a slot of a rotating shaft, the shaft positioned such that the slot is aligned within an opening of the ratchet nut. The pawls are positioned between an engaged position, to engage the ratchet nut and prevent rotation of the shaft relative to the ratchet nut, and a retracted position, to enable rotation of the shaft relative to the ratchet nut. The pawl includes an engagement surface configured to engage the ratchet nut and a non-engagement surface opposite the engagement surface, the non-engagement surface including an alignment bore configured to receive an alignment pin.

In some embodiments, the non-engagement surface includes a biasing mechanism bore disposed adjacent the alignment bore configured to receive a biasing mechanism at least partially therein.

In other embodiments, the non-engagement surface includes a second biasing mechanism bore disposed adjacent the alignment bore configured to receive a second biasing mechanism at least partially therein.

In a fifth aspect, there is described a method of assembling a ratchet assembly that includes inserting an alignment pin within an alignment bore of a first pawl and inserting a biasing mechanism in a biasing mechanism bore of the first pawl. The method also includes aligning an alignment bore and a biasing mechanism bore of a second pawl with the alignment pin and the biasing mechanism. The method also includes positioning the first pawl with respect to the second pawl such that the alignment pin and the biasing mechanism are disposed within the alignment bore and the biasing mechanism bore of the second pawl. The method includes applying a force to compress the biasing mechanism and inserting the first and second pawls within a ratchet nut. The method also includes releasing the force such that the biasing mechanism biases the first and second pawls against the ratchet nut.

In still other embodiments, the method includes inserting a biasing mechanism in a second biasing mechanism bore of the first pawl.

Other aspects, features, and advantages will become apparent from the following detailed description when taken in conjunction with the accompanying drawings, which are a part of this disclosure and which illustrate, by way of example, principles of the inventions disclosed.

### DESCRIPTION OF THE FIGURES

The accompanying drawings facilitate an understanding of the various embodiments.

FIG. 1 is a perspective view of a ratchet assembly coupled to a worm shaft in accordance with this disclosure.

FIG. 1A is an exploded perspective view of the ratchet assembly and worm shaft of FIG. 1.

FIG. 2 is a top view the ratchet assembly of FIG. 1 in accordance with this disclosure.

FIG. 3 is a perspective view of a pawl of FIG. 1.

FIG. 4 is a section view of the pawl of FIG. 3.

FIG. 5A is a partial exploded section view of first and second pawls illustrated in FIGS. 1 and 1A.

FIG. 5B is a section view of the first and second pawls of FIG. 5A assembled prior to assembly of the ratchet assembly of FIGS. 1 and 1A.

### DETAILED DESCRIPTION

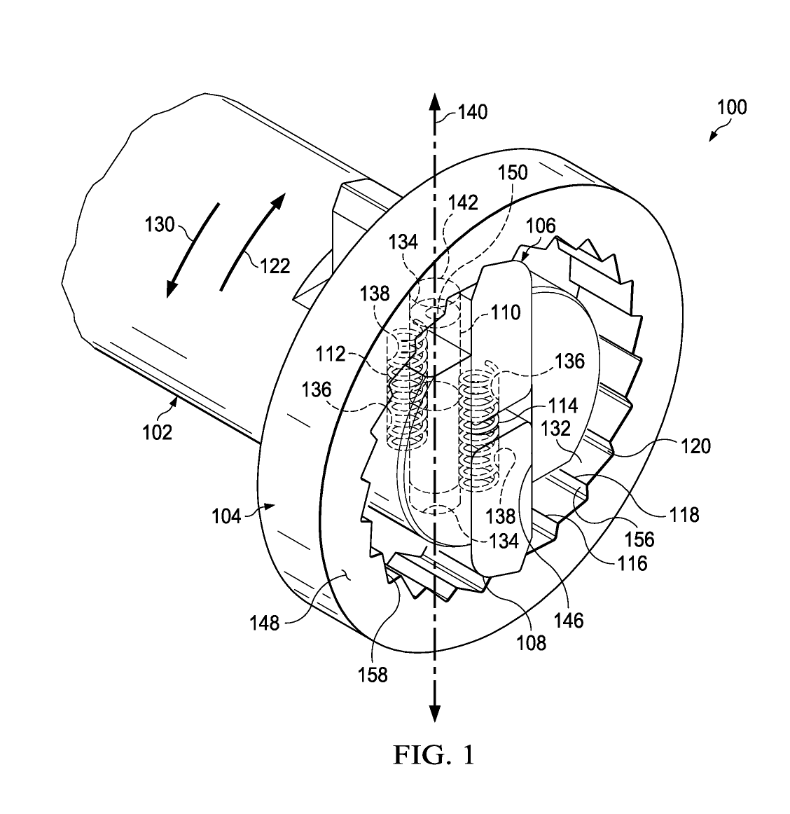

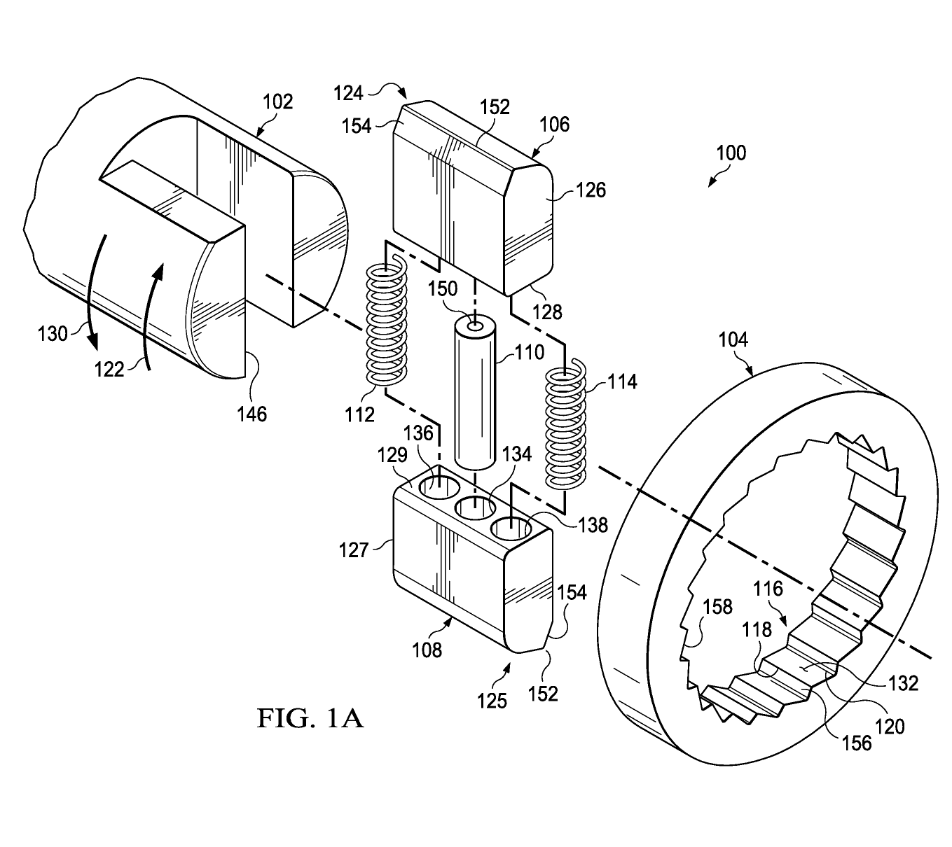

FIGS. 1, 1A and 2 illustrate a ratchet assembly 100 coupled to a worm shaft 102, the ratchet assembly 100 used for, among other functions, rotating an element of an oil well system, such as a sucker rod or production tubing (not shown) of a reciprocating oil pump (not shown), to thereby evenly distribute potential erosion and wear on a sucker rod or tubing surface typically caused by movement of the sucker rod during operation. In the embodiment illustrated in FIGS. 1, 1A and 2, the ratchet assembly 100 includes a ratchet nut 104, a first pawl 106 and a second and opposed pawl 108 disposed within the ratchet nut 104, an alignment pin 110 and first and second biasing mechanisms 112 and 114 disposed between the first and second pawls 106 and 108. As described in greater detail below, the alignment pin 110 constrains the movement of the pawls 106 and 108 along a common axis 140 to allow a user to more easily grasp and compress both pawls 106 and 108 during assembly of the ratchet 100. In addition to the alignment pin 110, the position of the first and second biasing mechanisms 112 and 114 disposed at least partially within first and second biasing mechanism bores 136 and 138 reduces the likelihood that the first and/or second biasing mechanisms 112 or 114 will unintentionally eject from between the first and second pawls 106 and 108 during assembly. This simplified design provides for a robust ratchet assembly 100 and simplified maintenance and operation, as will be described in more detail below.

In the embodiment illustrated in FIGS. 1, 1A and 2, the ratchet nut 104 is generally circular in shape and includes an opening 158 having a plurality of teeth 116. The worm shaft 102 is positioned relative to the opening 158 such that a slot 146 on the end of the worm shaft 102 is sized to receive the first and second pawls 106 and 108 therein, which are centrally disposed within the opening 158. The shape of the teeth 116, as discussed in greater detail below, allows for relative rotation between the ratchet nut 104 and the worm shaft 102 and allows for interlocking engagement between the ratchet nut 104 and the worm shaft 102, as will be described in more detail below. As illustrated in FIGS. 1 and 2, each tooth 116 is formed having a ridge 118, a valley 120, a sloped surface 132 extending between the ridge 118 and the valley 120, and a rear face 156 extending from the ridge 118 in a direction opposite from the sloped surface 132.

According to embodiments disclosed herein, the first pawl 106 and the second pawl 108 are diametrically opposed about a center of the ratchet nut 104. In the embodiment illustrated in FIG. 2, the first pawl 106 and the second pawl 108 each include angled engagement surfaces 124 and 125, bodies 126 and 127 and non-engagement surfaces 128 and 129, respectively, disposed opposite the engagement surfaces 124 and 125. The angled engagement surfaces 124 and 125 include a tip 152 and a rear facing portion 154 that are configured to slide along the sloped surface 132 of the teeth 116 to allow for relative rotation between the ratchet nut 104 and the worm shaft 102 and to frictionally interlock with the rear face 156 of the teeth 116 to prevent relative rotation between the ratchet nut 104 and the worm shaft 102. As illustrated in FIG. 1, for example, the bodies 126 and 127 are generally rectangular in shape and have a width that is similar to or otherwise the same as a width of the ratchet nut 104 although the size and shape of such bodies 126 and 127 may vary.

In the embodiment illustrated in FIGS. 1 and 1A, the alignment pin 110 is disposed within alignment bores 134 formed in both the first and second pawls 106 and 108. The alignment pin 110 is preferably hollow and includes openings 150 in the top and bottom ends (bottom opening not illustrated) to enable a lubricant to flow through (and around) the alignment pin 110 as the alignment pin 110 moves relative to the alignment bores 134 of the first and second pawls 106 and 108. Such lubricant helps to facilitate smooth and unrestricted movement of the first and second pawls 106 and 108 during operation.

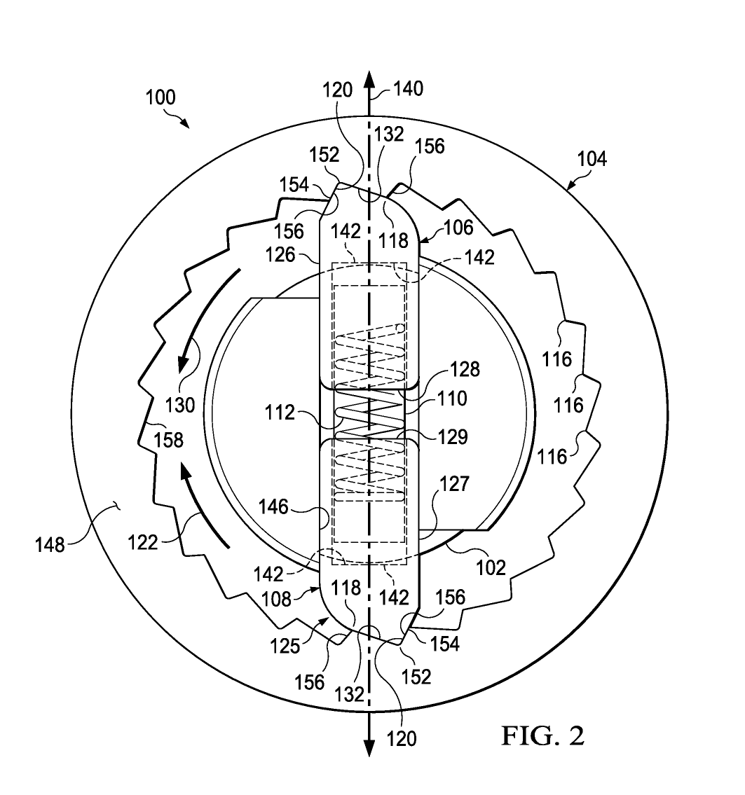

Referring specifically to FIGS. 2-4, the alignment bore 134 is centrally located along the axis 140 such that when the alignment pin 110 is disposed within the alignment bore 134, the pawls 106 and 108 are aligned and move linearly along the axis 140 between an extended or engaged position (i.e., when the tips 152 are located in the valleys 120 of two oppositely situated teeth 116 of the ratchet nut 104) and a retracted position (i.e, when the tips 152 are in contact with the ridges 118 of two oppositely situated teeth 116 of the ratchet nut 104). As illustrated particularly in FIGS. 2-4, the alignment bore 134 includes opposed contact surfaces 142 to constrain movement of the alignment pin 110 within the alignment bore 134.

Similarly, the first biasing mechanism bore 136 and the second biasing mechanism bore 138 each include a contact surface 144 to contact and otherwise support the ends of the first and second biasing mechanisms 112 and 114. In some embodiments, the pawls 106 and 108 include more than two biasing mechanism bores 136 and 138 formed in the non-engagement surfaces 128 and 129. In other embodiments, the pawls 106 and 108 include a single biasing mechanism bore 136 or 138 formed in the non-engagement surfaces 128 and 129. In still other embodiments, the non-engagement surfaces 128 and 129 each include a single bore 134 to house the alignment pin 110 and a single biasing mechanism 112 or 114 therein. In such an embodiment, the single biasing mechanism 112 or 114 encircles and is coaxially aligned with the alignment pin 110. In the embodiments illustrated herein, the biasing mechanisms 112 and 114 are illustrated as coil springs; however, such embodiments are not limited as such. For example, biasing mechanisms 112 and 114 may include other types of springs and/or hydraulically actuated biasing mechanisms 112 and 114.

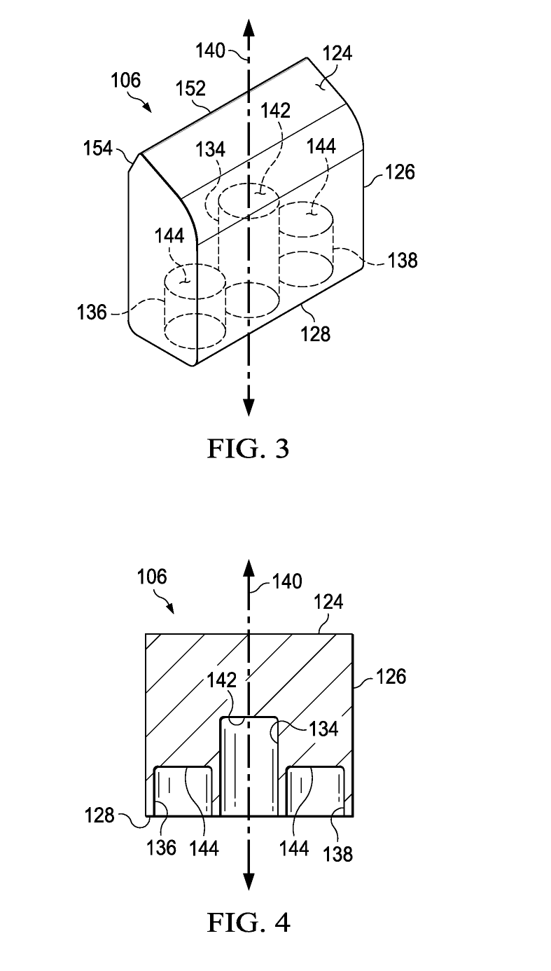

Referring specifically to the embodiment illustrated in FIGS. 1 and 4, for example, the depth of the alignment bore 134 is greater than the depth of the biasing mechanism bores 136 and 138. The depth of the alignment bore 134, the first biasing mechanism bore 136 and the second biasing mechanism bore 138 each correspond generally to the size of the alignment pin 110, the first biasing mechanism 112 and the second biasing mechanism 114, respectively. In the embodiment illustrated in FIGS. 1 and 4, the first biasing mechanism bore 136 and the second biasing mechanism bore 138 are formed with equal depths so that the first and second biasing mechanisms 112 and 114 apply equal biasing forces to the pawls 106 and 108. In addition, the first biasing mechanism bore 134 is located at the same distance from the alignment bore 134 as the second biasing mechanism bore 138 so that spring forces generated by first and second biasing mechanisms 112 and 114 are apply equally to the pawls 106 and 108.

According to embodiments disclosed herein, the outer diameter of the bores 134, 136 and 138 is slightly larger than the outer diameter of the alignment pin 110, the first biasing mechanism 112 and the second biasing mechanism 114, respectively. This enables relative movement between the alignment pin 110 and the alignment bore 134 and facilitates the compressioning of the first and second biasing mechanisms 112 and 114 within the bores 136 and 138. The bores 134, 136 and 138 are cylindrical in shape in the embodiment shown in FIG. 1. In other embodiments, the bores 134, 136 and 138 have other cross-sectional shapes, such as, for example, a square cross-sectional shape, a rectangular cross sectional shape and a triangular cross-sectional shape. In some embodiments, the bores 134, 136 and 138 have cross-sectional shapes that correspond to the outer perimeter of the alignment pin 110, the first biasing mechanism 112 and the second biasing mechanism 114, respectively.

Referring again to FIG. 2, the non-engagement surfaces 128 and 129 of the first and second pawls 106 and 108 face each other when the pawls 106 and 108 are disposed in the slot 146 of the worm shaft 102. As such, the alignment bores 134, the first and second biasing mechanism bores 136 and 138 in the first and second pawls 106 and 108 face each other and are otherwise aligned along a plane that is perpendicular to a top surface 148 of the ratchet nut 104. In some embodiments, a space remains between the non-engagement surfaces 128 and 129 when the first and second pawls 106 and 108 are in the retracted position. In other embodiments, the non-engagement surfaces 128 and 129 of the first and second pawls 106 and 108 contact each other when the first and second pawls 106 and 108 are in the retracted position.

In operation, the slot 146 and the alignment pin 110 restrict movement of the first and second pawls 106 and 108 to linear movement along the axis 140. Similarly, the slot 146 and the biasing mechanisms 112 and 114 restrain rotational movement of the first and second pawls 106 and 108 so that the first and second pawls 106 and 108 remain aligned and otherwise engaged with the teeth 116 of the ratchet nut 104. As such, the first and second pawls 106 and 108 are maintained in the correct position due to the design of the ratchet 100 and further, the assembly of the ratchet 100 is greatly simplified, as explained in greater detail below.

In use, the ratchet nut 104 is coupled to a reciprocating lever arm (not shown) of a rod rotator to transfer reciprocating motion of the lever arm to rotational movement of the worm shaft 102 via the ratchet nut 104. The worm shaft 102 and the ratchet nut 104 are initially positioned as shown in FIG. 2 such that the pawls 106 and 108 are in the extended/engaged position. Movement of the lever arm causes rotation of the ratchet nut 104 in the direction of arrow 122, which frictionally interlocks the rear faces 156 of the two opposing teeth 116 with the rear facing portions 154 of the pawls 106 and 108. Forces applied by the teeth 116 onto the pawls 106 and 108 cause the worm shaft 102 to also rotate in the direction of arrow 122. Once the worm shaft 102 has rotated a specified distance, the lever arm reverses its direction of movement causing the ratchet nut 104 to reverse its direction of rotation (i.e., to move in the direction of arrow 130). As the ratchet nut 104 rotates in direction of arrow 130, the angled engagement surfaces 124 and 125 of the pawls 106 and 108 slide along the surfaces 132 of the two opposing teeth 116. As a result, the pawls 106 and 108, which are guided by the alignment pin 110, retract linearly towards each other along the axis 140. As the pawls 106 and 108 retract, potential energy is stored in the biasing mechanisms 112 and 114 to facilitate movement of the pawls 106 and 108 back to the extended position in response to further rotation of the ratchet nut 104.

As the ratchet nut 104 continues to rotate in the direction of arrow 130, the tips 152 contact the ridges 118 of the two opposing teeth 116. In this position, the pawls 106 and 108 are in the fully retracted position and the biasing mechanisms 112 and 114 have stored an increased amount of potential energy. As the ratchet nut 104 continues to rotate in the direction of arrow 130, the tips 152 of the pawls 106 and 108 slide past the ridges 118 and the pawls 106 and 108 are biased outwardly via biasing mechanisms 112 and 114 so as to be positioned within the valleys 120 of the adjacently positioned and opposed teeth 116. Thus, when the tips 152 are disposed in the valleys 120, the rear facing portion 154 of the angled engagement surfaces 124 and 125 once again contacts and otherwise abuts/engages the rear faces 156 of the two opposed teeth 116. The above-described process repeats to incrementally rotate the worm shaft 102 as the lever arm continues to alternate its direction of motion causing the ratchet nut 104 to alternate between rotation in the direction of arrow 122 and rotation in the direction of arrow 130.

In some embodiments, a rod rotator includes a single ratchet 100 to transfer rotational motion from the lever arm (not shown) to the worm shaft 102. In other embodiments, the rod rotator includes two ratchet assemblies 100 coupled to the worm shaft 102: a first ratchet assembly 100 used to transfer rotational motion from the lever arm to the worm shaft 102 and a second ratchet assembly 100 to simultaneously allow rotation of the worm shaft 102 in one direction while preventing rotation of the worm shaft 102 in an opposite direction. For example, in some embodiments, a first ratchet 100 is coupled to the slot 146 on a first end of the worm shaft 102 and a second ratchet 100 is coupled to a slot 146 on a second end of the worm shaft 102. The second ratchet 100, and in particular, the ratchet nut 104, is fixedly secured to a housing (not shown) of the rod rotator to simultaneously allow rotation of the worm shaft 102 in the direction of arrow 122 and prevent rotation of the worm shaft 102 in the direction of arrow 130.

In use, rotation of the worm shaft 102 in the direction of arrow 122 causes the angled engagement surfaces 124 and 125 of the pawls 106 and 108 of the second ratchet 100 to travel or otherwise slide along the surfaces 132 of the two opposing teeth 116. As described above, the pawls 106 and 108 retract linearly towards each other along the axis 140 and potential energy is stored in the biasing mechanisms 112 and 114. As the worm shaft 102 continues to rotate in the direction of arrow 122, the tips 152 contact the ridges 118 of the two opposing teeth 116 and eventually travel past the ridges 118. The pawls 106 and 108 are then biased outwardly via biasing mechanisms 112 and 114 so as to be positioned within the valleys 120 of the adjacently positioned and opposed teeth 116. When the tips 152 are disposed in the valleys 120, the rear facing portion 154 of the angled engagement surfaces 124 and 125 contacts and otherwise abuts the rear faces 156 of the two opposed teeth 116 to prevent the worm shaft 102 from rotating in the direction of arrow 130. The above-described process repeats to simultaneously allow rotation of the worm shaft 102 in the direction of arrow 122 while preventing rotation of the worm shaft 102 in the direction of arrow 130. While the operation of the ratchet 100 has been described in connection with a rod rotator, it will be understood by one of ordinary skill in the art that the ratchet 100 can be incorporated and used in other mechanisms to rotate other objects, such as, for example, mechanisms to rotate a production tubing of an oil well.

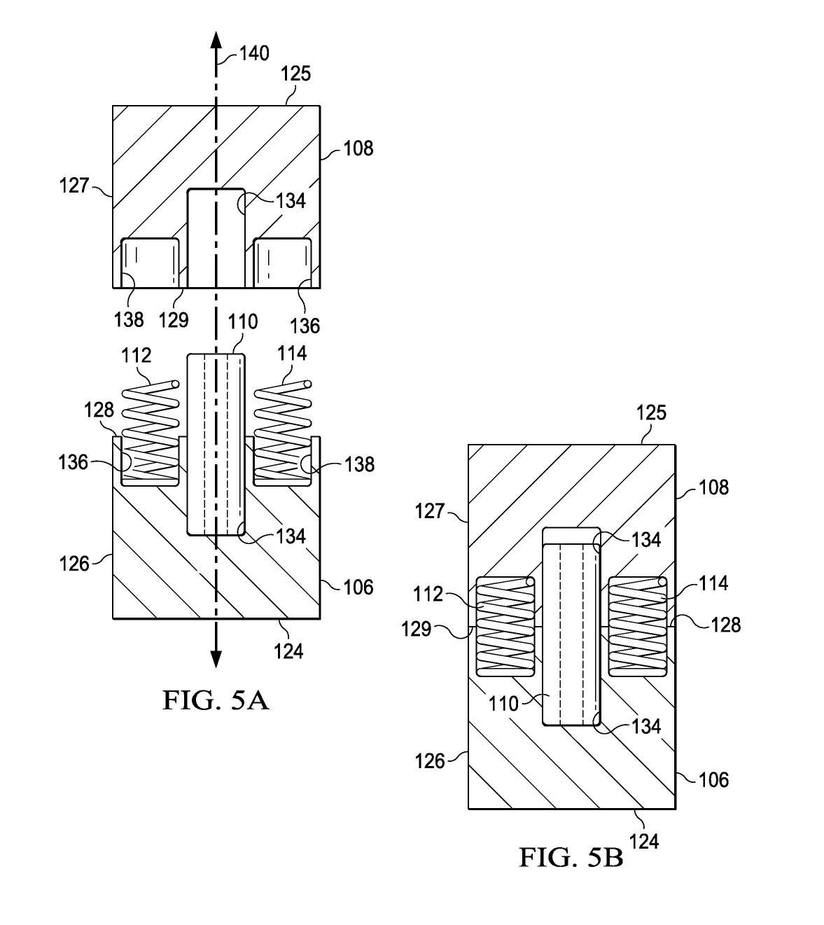

Referring now to FIGS. 5A and 5B, when assembling the ratchet 100, the alignment pin 110 and the first and second biasing mechanisms 112 and 114 are disposed in the alignment bore 134, the first biasing mechanism bore 136 and the second biasing mechanism bore 138, respectively, of the first pawl 106. In some embodiments, the user adds one or more lubricants or other substances to the bores 134, 136 and/or 138 prior to positioning the alignment pin 110, the first biasing mechanism 112 and the second biasing mechanism 114 in the alignment bore 134, the first biasing mechanism bore 136 and the second biasing mechanism bore 138, respectively.

The alignment pin 110 and the biasing mechanisms 112 and 114 are aligned with the corresponding bores 134, 138 and 136 in the second pawl 108. Once aligned, the pawls 106 and 108 are then moved toward each other to that the bores 134, 136 and 138 enclose the pin 110 and biasing mechanisms 112 and 114. Movement of the pawls 106 and 108 continues until the surface 129 of the second pawl 108 contacts, or nearly contacts, the surface 128 of the first pawl 106, as best illustrated in FIG. 5B. When positioned as illustrated in FIG. 5B, the biasing mechanisms 112 and 114 exert an opposed biasing force against the first and second pawls 106 and 108.

When the surfaces 128 and 129 abut and/or otherwise contact each other and the alignment pin 110 engages the alignment bores 134 of the first and second pawls 106 and 108, an installer can hold the first and second pawls 106 and 108 by maintaining an inward force on the engagement surfaces 124 and 125 of the first and second pawls 106 and 108. The contact between the surfaces 128 and 129 coupled with the use of the alignment pin 110 reduces and/or substantially eliminates the likelihood that the first and second pawls 106 and 108 will rotate or otherwise misalign, thus resulting in an ejection of one or both of the biasing mechanisms 112 and 114 as the user inserts the pawls 106 and 108 into the slot 146 and ratchet nut 104. As such, the configuration of the pawls 106 and 108 facilitates a more convenient and simple assembly of the ratchet 100.

Referring back to FIG. 1, the installer then inserts the pawls 106 and 108, when compressed, into the slot 146 and inserts the worm shaft 102 and the pawls 106 and 108 within the ratchet nut 104. Once the user places the first and second pawls 106 and 108 within the ratchet nut 104, the first and second pawls 106 and 108 are released so that the biasing force of the first and second biasing mechanisms 112 and 114 moves and/or otherwise positions the first and second pawls 106 and 108 outwardly until the engagement surfaces 124 and 125 contact and otherwise interlock with the teeth 116 of the ratchet nut 104.

Embodiments disclosed herein advantageously provide a ratchet 100 that includes an alignment pin 110 to constrain the lateral movement of the pawls 106 and 108 along an axis 140, and thus unintentional ejection of the biasing mechanisms 112 and 114. This enables an installer to more easily grasp and compress both pawls 106 and 108 and while assembling the ratchet assembly 100. In addition, embodiments disclosed herein provide that the position of the first and second biasing mechanisms 112 and 114 disposed at least partially within first and second biasing mechanism bores 136 and 138 reduces and/or otherwise eliminates the likelihood that the first and/or second biasing mechanisms 112 or 114 will unintentionally eject from between the first and second pawls 106 and 108 during assembly. This simplified design provides for a robust ratchet assembly 100 and simplified maintenance and operation.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “clockwise” and “counterclockwise”, “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A ratchet assembly, comprising:
a ratchet nut;
a shaft at least partially disposed within the ratchet nut;
a first and a second pawl disposed within the ratchet nut and supported by the shaft, the first and second pawls movable along a common central axis;
a biasing mechanism, the biasing mechanism biasing the first and second pawls in an engaged position to maintain contact with the ratchet nut to prevent relative rotation between the shaft and the ratchet nut; and
an alignment pin extending at least partially within the first and second pawls to maintain alignment and to facilitate movement of the pawls along the common central axis.

2. The ratchet of claim 1, wherein the first and second pawls each include an engagement surface configured to engage the ratchet nut and a non-engagement surface opposite the engagement surface, the non-engagement surfaces each including an alignment bore to receive the alignment pin therein.

3. The ratchet of claim 1, wherein the alignment pin includes a hollow interior.

4. The ratchet of claim 1, wherein the ratchet nut is secured in a stationary position to facilitate rotational movement of the shaft relative to the ratchet nut.

5. The ratchet of claim 1, wherein the first and second pawls each include a rectangular body having an angled engagement surface to engage the ratchet nut.

6. The ratchet of claim 2, wherein the non-engagement surfaces each include a biasing mechanism bore disposed adjacent the alignment bore, wherein the biasing mechanism is at least partially disposed within the biasing mechanism bores.

7. The ratchet of claim 6, wherein the non-engagement surfaces each include a second biasing mechanism bore disposed adjacent the alignment bore, wherein a second biasing mechanism is at least partially disposed within the second biasing mechanism bores.

8. The ratchet of claim 7, wherein the alignment bores of the first and second pawls are located between the first biasing mechanism bores and the second biasing mechanism bores.

9. The ratchet of claim 2, wherein the first and second pawls are disposed within an opening in the ratchet nut so that the engagement surfaces contact opposite interior surfaces of the opening.

10. A ratchet assembly, comprising:
a ratchet nut comprising a central opening and an interior surface comprising a plurality of teeth;
a first pawl comprising an engagement surface and a non-engagement surface opposite the engagement surface, wherein the non-engagement surface comprises an alignment bore;
second pawl comprising an engagement surface and a non-engagement surface opposite the engagement surface, wherein the non-engagement surface comprises an alignment bore; and
an alignment pin disposed at least partially within the alignment bores to constrain movement of the pawls along a common axis to engage the engagement surfaces of the first and second pawls with opposed teeth of the ratchet nut.

11. The ratchet of claim 10, further comprising a shaft having a slot, wherein the first pawl and the second pawl are at least partially positioned within the slot.

12. The ratchet of claim 10, wherein the ratchet nut is secured in a stationary position to facilitate rotational movement of the shaft relative to the ratchet nut.

13. The ratchet of claim 10, further including a biasing mechanism disposed between the first pawl and the second pawl to position the engagement surfaces of the first and second pawls against internal surface of the ratchet nut.

14. A method of manufacturing a ratchet assembly, comprising:
providing a first pawl and forming an alignment bore and a biasing mechanism bore therein;
providing a second pawl and forming an alignment bore and a biasing mechanism bore therein;
inserting an alignment pin between the first pawl and the second pawl so that the pin is at least partially positioned within the alignment bores; and
inserting a biasing mechanism between the first pawl the second pawl so that the biasing mechanism is at least partially positioned within the biasing mechanism bores of the first and second pawls.

15. The method of claim 14, further comprising moving the first pawl toward the second pawl to compress the biasing mechanism.

16. The method of claim 15, further comprising inserting the first pawl and the second pawl within an internal opening of a ratchet nut.

17. The method of claim 16, further comprising inserting the first pawl and the second pawl into a slot of a worm shaft.

18. The method of claim 17, further comprising releasing the first and second pawls such that the biasing mechanism moves first pawl away from the second pawl so that the first pawl and the second pawl contact opposite sides of the internal opening of the ratchet nut.

19. The method of claim 14, further comprising forming an opening in the alignment pin that extends along the longitudinal axis of the alignment pin.

20. The method of claim 14, further comprising forming a second biasing mechanism bore on the first and second pawls and placing an additional biasing mechanism within the second biasing mechanism bores.

21. A pawl for use with a ratchet assembly, the ratchet assembly including a ratchet nut and first and second pawls disposed within a slot of a rotating shaft, the shaft positioned such that the slot is aligned within an opening of the ratchet nut, the pawls positioned between an engaged position, to engage the ratchet nut and prevent rotation of the shaft relative to the ratchet nut, and a retracted position, to enable rotation of the shaft relative to the ratchet nut, the pawl comprising:
an engagement surface configured to engage the ratchet nut and a non-engagement surface opposite the engagement surface, the non-engagement surface including an alignment bore configured to receive an alignment pin.

22. The pawl of claim 21, wherein the non-engagement surface further comprises a biasing mechanism bore disposed adjacent the alignment bore configured to receive a biasing mechanism at least partially therein.

23. The pawl of claim 22, wherein the non-engagement surface further comprises a second biasing mechanism bore disposed adjacent the alignment bore configured to receive a second biasing mechanism at least partially therein.

24. A method of assembling a ratchet assembly, comprising:
inserting an alignment pin within an alignment bore of a first pawl;
inserting a biasing mechanism in a biasing mechanism bore of the first pawl;
aligning an alignment bore and a biasing mechanism bore of a second pawl with the alignment pin and the biasing mechanism; and
positioning the first pawl with respect to the second pawl such that the alignment pin and the biasing mechanism are disposed within the alignment bore and the biasing mechanism bore of the second pawl;
applying a force to compress the biasing mechanism;
inserting the first and second pawls within a ratchet nut; and
releasing the force such that the biasing mechanism biases the first and second pawls against the ratchet nut.

25. The method of claim 24, further comprising inserting a biasing mechanism in a second biasing mechanism bore of the first pawl.
